(19) United States
(12) Patent Application Publication
(10) Pub. No.: US 2024/0289703 A1
(43) Pub. Date: Aug. 29, 2024

(54) Process and Apparatus for Organizing Digital and Customized Tourist Itineraries

(71) Applicant: Giorgio GARAVELLI, Torino (IT)

(72) Inventor: Giorgio GARAVELLI, Torino (IT)

(21) Appl. No.: 18/024,862

(22) PCT Filed: Sep. 3, 2021
(86) PCT No.: PCT/IT2021/050271

§ 371 Date: Mar. 6, 2023

(30) Foreign Application Priority Data
Sep. 11, 2020 (IT) 102020000021580

(51) Int. Cl. G06Q 10/0631

(52) U.S. Cl. CPC G06Q 10/06311

(57) ABSTRACT

A process is described for organizing flexible and customized tourist itineraries, including the steps of: providing an apparatus (1) for processing and management; providing a first database (3) containing geographic and tourist data of places of interest; providing a second database (5) containing user data; registering a user; entering location data and duration of the tourist itinerary; entering data relating to the stimuli and the type of itinerary; displaying to the user a plurality of sections representing the following themes; one of the 4 historical periods, and the art form between 4 categories; displaying to the user at least one photo for each value; processing the preferences entered by the user; and computing the preferences on each mapped place and present an itinerary with the number of places to visit, visit time and distance to be traveled.

The present invention refers to a process and an apparatus for organizing digital and customized tourist itineraries, which accompanies people to discover new cultures through the story of the traditions, art and history of a city or a place of tourist interest.

Currently, people often base the organization of a cultural trip on online (non-customized) advice and guides. The process takes time and energy when a person has to search for what is best for him, without knowing the places and activities at his destination.

The main problems encountered are:
1) time lost in research: there are many things to do and visit in a city. To organize a visit, a person must see them all, read guides and look for “things to do”;
2) difficulty in finding organized and complete contents of attractions: people want to understand local culture and traditions. It is difficult to find relevant content for each place, especially for smaller or less famous places;
3) fear of missing something important: most people can only spend a limited time getting information about the destination. It is almost impossible to consider all tours and all places to visit, and therefore people are afraid of missing some tourist points of interest.

Object of the present invention is solving the aforementioned prior art problems, providing a process and an apparatus for organizing flexible and customized tourist itineraries, which provide the following characteristics:
1) automated tourism with a digital guide: possibility of organizing an itinerary that is flexible (it can start and end at any time and from anywhere you want) and customized (based on personal interests, which can change at any time);
2) integrated quality content: each mapped location also has a page of content presenting: historical and artistic relevance, interventions during its history, traditional legends and curiosities, and all tourist information (opening hours, estimated time of visit, admission ticket price);
3) mapping of all the places of interest in the city: the database has all the cultural references of a city, from the “top” and most famous attraction, to “hidden gems”. There is no need to actively search for places-you are notified every time you come across them.

The advantages of the inventive process and apparatus are:
a) customization: an infinite number of possible itineraries based on your interests and which can be modified at any time
b) database: all positions are mapped and the contents are written by academics and specialists
c) ease of use: there is no need to consult hundreds of websites or guides: everything is in one place and the Application sends notifications relating to the place that the user has encountered
d) completely focused on tourist services in the destination: costs, time and energy are saved by focusing on services for the traveler in the destination
e) incentives for suppliers: tour guides will have the possibility to create their own digital tours and reach the maximum capacity of their tours by aggregating other people during the tour itself
f) design: a simple design and attractive descriptions can break the barrier between cultural and artistic content and the public.

The above and other objects and advantages of the invention, as will appear from the following description, are achieved with a process and an apparatus organizing digital and customized tourist itineraries such as those described in the respective independent claims. Preferred embodiments and non-trivial variants of the present invention form the subject of the dependent claims.

It is understood that all the attached claims form an integral part of the present description.

The present invention will be better described by some preferred embodiments, provided by way of non-limiting example, with reference to the attached drawings, in which:

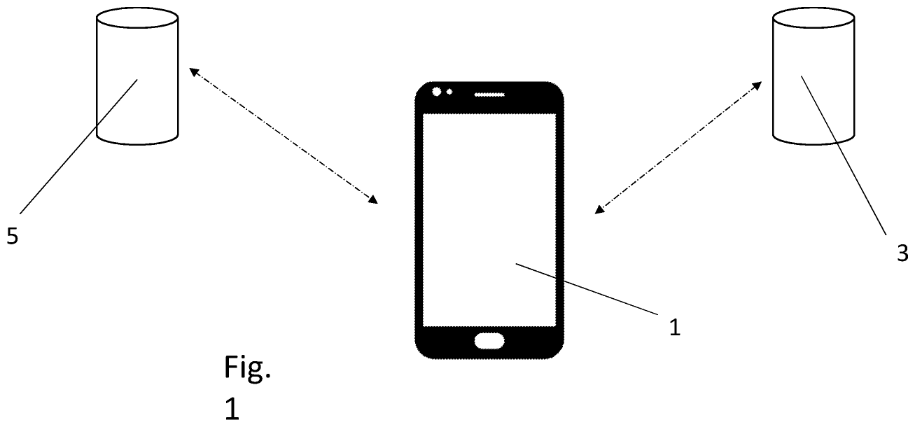

FIG. 1 is a schematic view of an implementation of the apparatus according to the present invention; and

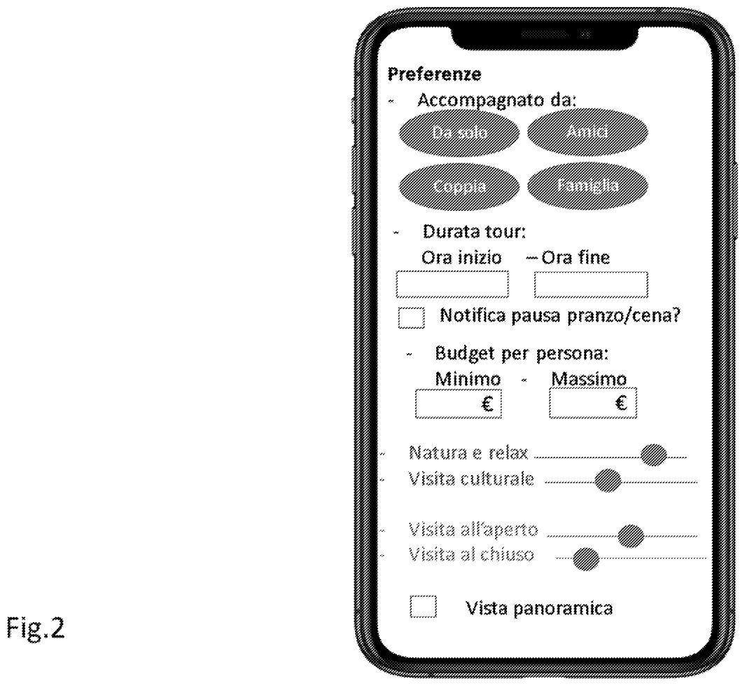

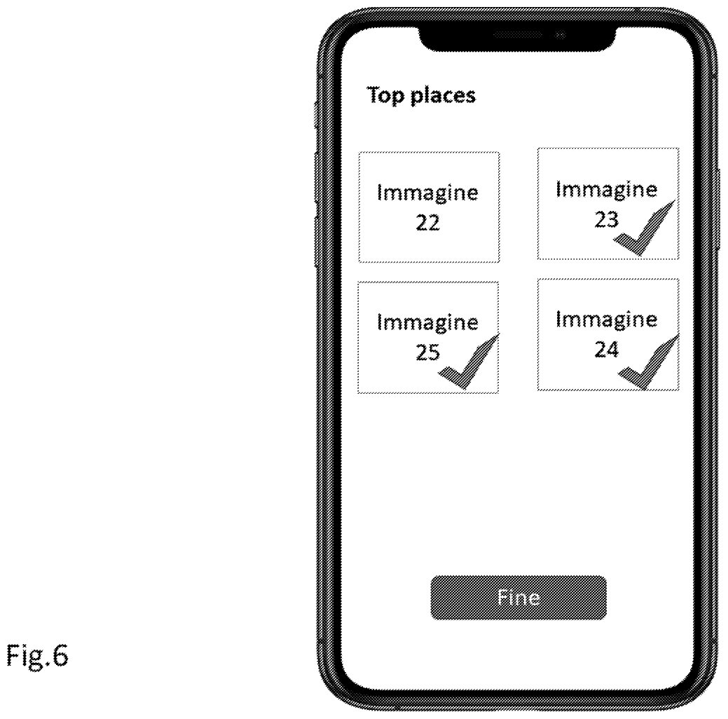

FIGS. 2 to 7 are schematic views of screens and functions of the process according to the present invention.

With reference to the Figures, a preferred embodiment of the present invention is illustrated and described. It will be immediately obvious that innumerable variations and modifications (for example relating to shape, dimensions, various colors and parts with equivalent functionality) can be made to what is described without departing from the scope of the invention as appears from the attached claims.

With reference to FIG. 1, an exemplary and absolutely non-limiting embodiment of the environment in which the process of the present invention operates is illustrated. This environment comprises a processing and management apparatus 1 (preferably a smartphone, but which could be any processing apparatus of the mobile or fixed type, computer, tablet, laptop, palmtop, etc.) operatively connected to at least a first database 3 containing geographic and tourist data of places of interest, and at least a second database 5 containing user data. It is obvious that these databases 3, 5 could be incorporated into a single database, or divided into additional databases, both physical, and located on the cloud or on other media.

Database 3 includes a list of places and artistic works identified by their title and geographical location (address). Data are divided into two sections; in the first, the places are divided into first-level and second-level types which reveal their identifying characteristics.

These types are:
Architecture
1. Entertainment buildings
2. Public building
3. Architectural element
4. Gallery
5. Place of worship
6. Museum
7. Palace
8. Porch
9. Dynastic residence
   Pictorial work
   Sculptural work
1. Fountain
2. Installation
3. Monument
4. Relief
5. Statuary
   Archaeological Site
   Park/garden
   Urban planning
1. Square
2. Street
   Special

These characterizations are represented on the map by vector pins of different colors (identification by type of first level) and symbols/icons (by type of second level).

For each place a subtitle is inserted with an explanatory function.

For some places, the opening hours, the cost of the ticket (if any) and an estimated visit time are also entered.

Each place has a content sheet organized as follows:
1. a section of the historical-artistic description of the place, consisting of a part of the text and one or more photographs of the place itself;
2. a section describing the legends or curiosities relating to the place, consisting of a part of the text and a photograph for each legend or curiosity described in the text;
3. a section of restoration interventions, modifications or reconstruction of the place or work that took place during its history and organized according to: type of intervention, date of intervention and artists involved;
4. an in-depth section (understood as works that are part of the place but that are independent from the structure of the place itself), consisting of the title of the work, the date of creation, the name of the artist, a section of text of description of the work and a photo of the work described.

The “content” section includes data on the structure of the place or work. The data is sorted in a Table where each row (record) corresponds to the place or work, and each column an attribute. The attributes are identified by 5 macro categories which are in turn divided into subcategories.

Below is the composition of the attributes of the Table:
1. Historical period and territorial areas,
   1.1 Ancient Age;
   1.2 Medieval Age;
   1.3 Modern Age;
   1.4 Contemporary Age;
2. Legends and curiosities-historical period,
   2.1 “Not applicable”;
   2.2 Ancient Age;
   2.3 Medieval Age;
   2.4 Modern Age;
   2.5 Contemporary Age;
3. Form of art,
   3.1 Painting;
   3.2 Sculpture/monument;
   3.3 Architecture,
   3.3.1 Church-Palace-Building;
   3.3.2 Museum;
   3.3.3 Garden-park;
   3.3.4 Urban planning;
   3.4 Minor art;
   3.4.1 Generic;
   3.4.2 Mosaic;
   3.4.3 Textile;
   3.4.4 Porcelain;
   3.4.5 Jewelry;
   3.4.6 Cabinet making;
   3.5 Drawing and engraving;
   3.6 Design;
   3.7 Literature;
   3.8 Music;
   3.9 Theater;
   3.10 Cinema;
   3.11 Photography;
   3.12 Documentation;
4. Subject and pictorial genres,
   4.1 Not applicable;
   4.2 Religious;
   4.3 History;
   4.4 Mythological;
   4.5 Allegorical;
   4.6 Portrait;
   4.7 Landscape;
   4.8 Genre painting;
   4.9 Still life;
5. Values,
   5.1 Functional;
   5.2 Symbolic;
   5.3 Sacred;
   5.4 Social;
   5.5 Political;
   5.6 Celebratory;
   5.7 Personal;

In the table there are 3 other columns whose attributes are not directly attributable to the structure of the place or work but identify qualities attributable to the search for the place and its value in the external context. The three attributes are:
1. Artists involved;
2. “Photogenicity”;
3. Panoramic view;

The intersection value between entities (rows) and attributes (columns) can be a percentage or a null value (equivalent to zero). The magnitude of the percentage value is attributable to each subgroup with reference to the macro-category to which it belongs.

The sum of the percentage values of the subcategories must be equal to 100% of the macro-category to which they are included. Each macro-category must have a total sum equal to 100%. An example:

| Historic period and | | | | Legends and curiosities - | | | | |
|---|---|---|---|---|---|---|---|---|
| territorial purview | | | | historical period | | | | |
| Ancient | Medieval | Modern | Contemporary | | Ancient | Medieval | Modern | Contemporary |
| Age | Age | Age | Age | N/A | Age | Age | Age | Age |

| | | | | | |
|---|---|---|---|---|---|
| Sample | 0.10 | 0.40 | 0.50 | 0.30 | 0.70 |
| place | | | | | |

As regards the three “external attributes”, the values are represented as follows:
Artists involved: name and surname of the artist/artists;
“Photogenicity”: percentage value, expression of the level of “photographic interest” of the tourist;
Panoramic view: check box to indicate the presence (in the immediate surroundings or accessible via the place) of an area with a view of the surrounding landscape.

The process of the present invention, after having foreseen the presence of such apparatus 1 and databases 3 and 5, provides for a series of steps, which are presented to the user on the screen of the apparatus 1, and which have been represented in FIGS. 2 to 7 in their salient aspects.

After the activation, for example, of an Application (APP) that is run on device 1, a user registration is expected with the relative insertion of their personal data in the second database 5.

After registering with the app (via email and password, or via Facebook credentials), the user must select the city where the visit will be made, if not already done previously. The user will be presented with the map of the city; places will not be displayed in the user interface yet. It will present only the urban layout, and a pointer to the user's position (if he has activated geolocation on his device) without other additional elements.

The places will be identified on the map when the user enters a certain radius from the place. The user will be notified of the newly “discovered” place and a location icon (pin) will appear with a color and a symbol defined according to the specifications entered in the database 3.

In the map view, there will be an icon that will allow the user to take advantage of the “custom route calculation” feature.

Once selected, a first screen appears on the display of device 1 (FIG. 2) in which the user enters location data, duration of the tourist itinerary, and other information. This entry phase is designed to filter the places to be visit within a certain radius of the user and prepare the calculation of the travel time and the visit time, taking into account the maximum duration of the itinerary.

In FIG. 2, the main fields that appear to the user are:

“Tour duration”: starts filtering places within a certain radius of the user and prepares the calculation on travel time and visit time. It takes into account the maximum duration, beyond which the itinerary cannot go.

“Budget”: only for places with paid admission. If 0, all places that need to purchase a ticket are automatically deleted from the route calculation. If it is greater than 0, all places are taken into account; then he makes sure that the cost of the ticket is lower than the allocated budget. In the case of 2 or more “paid places” that can be included in the itinerary, the cost of X1+X2 must be < of the budget. For example, if the budget per person is set at € 20 and the first ticket costs € 15, it is advisable to visit the place. In the event that the tourist pays the ticket, the new budget for the tour will be 20−15=5 and therefore only the places with price <=€ 5 will be considered later.

The entry fields on the type of visit are:

“Nature and relaxation” and “Cultural visit”: they are used to establish a value that can be traced back to the type of place.

“Outdoor visit” and “Indoor visit”: they are used to establish a value attributable to the visit characteristic of the type of place.

The user will report these preferences via a scroll bar with values between 0 (zero) and 1 (one).

Below is a table with the constants that identify the relationships between the user input values (rows) and the types of places (columns):

TABLE 1

| | Architec- | Urban | Mus- | Garden/ | Archaeological |
|---|---|---|---|---|---|
| | ture | planning | eum | park | Site |
| Cultural visit | 0.2 | 0.15 | 0.25 | 0.05 | 0.2 |
| Nature and | 0.1 | 0.15 | 0.05 | 0.225 | 0.15 |
| relaxation | | | | | |
| Outdoor visit | 0.1 | 0.2 | 0.05 | 0.225 | 0.15 |
| Indoor visit | 0.15 | 0.05 | 0.2 | 0.05 | 0.05 |

The rules for “sculptural work” and “pictorial work” are the same as for the category “urban planning”.

Each value entered by the user in the 4 fields is multiplied by the constant value of every category, indicated in Table 1. A matrix is created with partial values for every category.

In this first phase, the machine will assign a score, given by the sum of the values obtained, to each place of the corresponding typology.

An example:

TABLE 2

| | User | | Urban | | Garden/ | Archaeological |
|---|---|---|---|---|---|---|
| | inputs | Architecture | planning | Museum | park | site |
| Cultural | 0.5 | [0.5] * | [0.5] * | [0.5] * | [0.5] * | [0.5] * |
| visit | | [0.2] = 0.1 | [0.15] = 0.075 | [0.25] = 0.125 | [0.05] = 0.025 | [0.2] = 0.1 |
| Nature | 0.85 | 0.085 | 0.1275 | 0.0425 | 0.19125 | 0.1275 |
| and | | | | | | |
| relaxation | | | | | | |
| Outdoor | 0.5 | 0.05 | 0.1 | 0.025 | 0.1125 | 0.075 |
| visit | | | | | | |
| Indoor | 0.3 | 0.045 | 0.015 | 0.06 | 0.015 | 0.015 |
| visit | | | | | | |
| Sum | | 0.28 | 0.3175 | 0.2525 | 0.34375 | 0.3175 |

The last optional entry parameter is the “panoramic view”, which can be selected if the user wishes to visit places with a view of the city or the surrounding landscape. When entering data in the database 3, a “yes” or a “no” is assigned for each place whether this parameter is present or not. Only if the user selects “panoramic view”, a score of 0.15 will be added only to places where a positive value has been entered for the “panoramic view”.

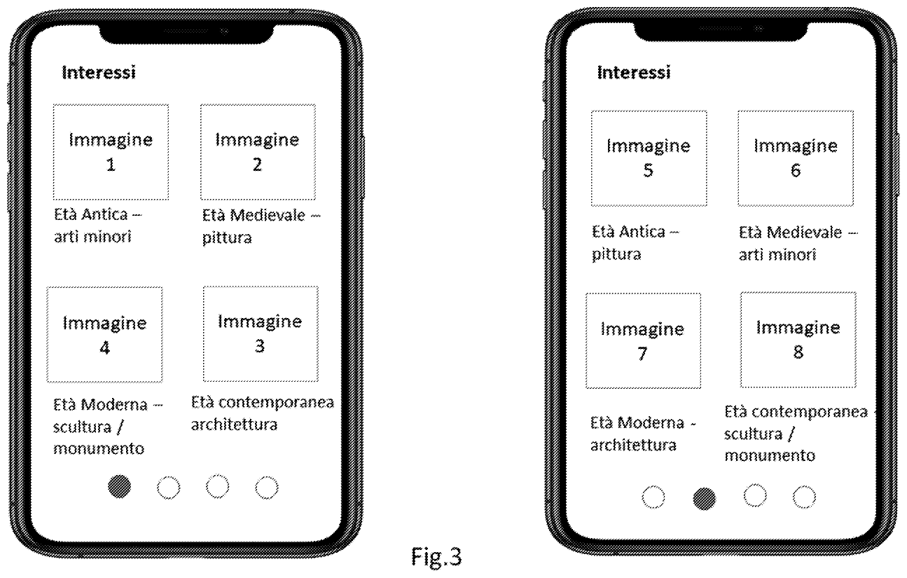

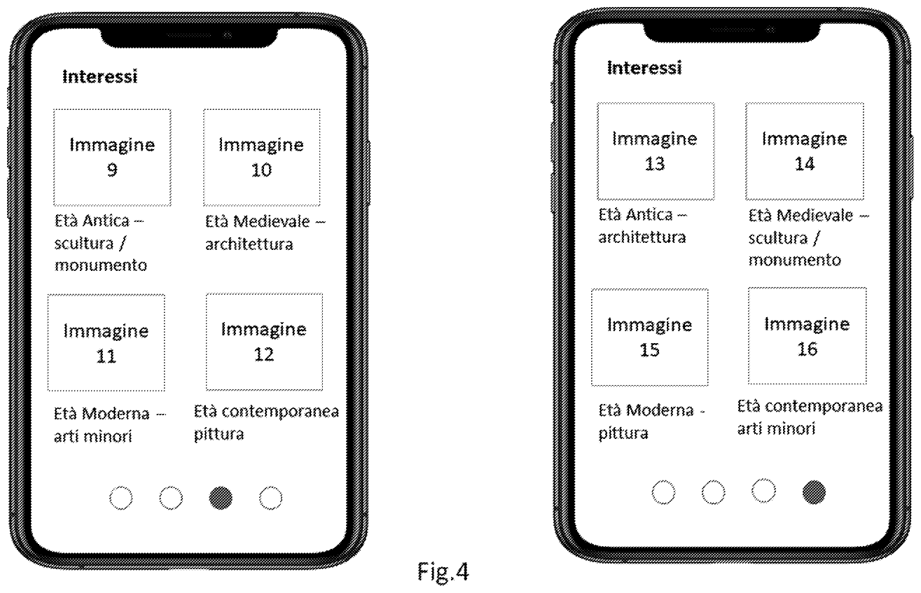

As shown in FIGS. 3 and 4, after this first screen, the second category of data entry concerns the assignment of historical-artistic preferences through 4 screens each consisting of 4 images. These images are representative of the 4 macro-categories present in “historical period and territorial areas” (Ancient Age, Medieval Age, Modern Age, Contemporary Age) and of 4 macro-categories present in “art form”: Sculpture/monument (including the “urban planning” category), Painting, Architecture (without the “urban planning” category), Minor Arts (including the categories: “design and engraving”, “literature”, “design”, “music”, “theater”, “cinema”, “photography”, “documentation”).

Each image represents 1 “art form” and 1 “historical period”.

Each screen contains 4 images, each with a different “art form”-“historical period” couple.

In the 4 screens it is not possible to repeat the same pair of macro-categories. This way there will be 16 different images on all screens.

The user, for each screen, will select and assign preferences by selecting the images in descending order (from best to worst) by assigning a value from 1 (best) to 4 (worst) according to the order of choice.

The value attributed to the image is weighted as follows: 1=1; 2=0.75; 3=0.50; 4=0.25.

An average of the scores assigned to each of the 4 representative images of each macro-category is calculated. The data thus collected will be used to attribute a numerical value to each of the 8 macro-categories. Here is an example:

TABLE 3

| | An- | | | | Average |
|---|---|---|---|---|---|
| | cient | Medieval | Modern | Contemporary | Art |
| | Age | Age | Age | Age | form |
| Minor arts | 1 | 0.75 | 0.75 | 0.25 | 68.75 |
| Pictorial works | 0.50 | 0.75 | 1 | 0.25 | 62.50 |
| Sculpures/ | 1 | 0.75 | 0.50 | 0.25 | 62.50 |
| Monuments | | | | | |
| Architecture | 0.50 | 0.50 | 1 | 0.25 | 56.25 |
| Average | 0.75 | 0.6875 | 0.8125 | 0.25 | |
| Historical period | | | | | |

These numerical values will be weighted with the values of the same categories for each place, attributing a “value of interest” to each category.

The values thus found will weighted by macro-category, resulting in two values: one for the “historical period” and 1 for the “form of art”.

Preferably, the “value of interest” can be calculated as follows: 1.1 Info-stimuli→sum by type of the 4 categories. Architecture=cultural+nature+open/closed+panoramic; Archaeological site=(same formula); etc., the value thus obtained being attributed to all the places identified with that typology; 2. View−characterization→proportion between average user values and attributes of the place; Historical period=average (ancient of the place*average ancient user+medieval of the place*average medieval user+etc.); Form of art=same formula of the historical period, both being calculated on each place and as a result being attributed two “values of interest” for each place; 3. Values−questions→given that the detection scale is the same as the attributes of the places, the correspondence between the user's values and the values of the place is detected by attributing a proportional weight with the same formula used in section “2. View-characterization” for “historical period” and “art form”, the “value of interest” for each place being the sum of each result.

Table 4 shows an example with numerical responses to a questionnaire and two typical places:

TABLE 4

| Question- | Database | Values | |
|---|---|---|---|
| naire | 3 | of interest | Average |

Place 1

| | | | | | |
|---|---|---|---|---|---|
| Historical | Ancient Age | 0.75 | 0 | 0 | 0.1680 |
| Period | Medieval Age | 0.6875 | 0 | 0 | |
| | Modern Age | 0.8125 | 0.75 | 0.6094 | |
| | Contemporary | 0.25 | 0.25 | 0.0625 | |
| | Age | | | | |
| Art forms | Minor arts | 0.6875 | 0 | 0 | 0.1445 |
| | Pictorial | 0.6250 | 0 | 0 | |
| | works | | | | |
| | Sculptures/ | 0.6250 | 0.25 | 0.1563 | |
| | monuments | | | | |
| | Architecture | 0.5625 | 0.75 | 0.4219 | |

Place 2

| | | | | | |
|---|---|---|---|---|---|
| Historical | Ancient Age | 0.75 | 0.10 | 0.075 | 0.1594 |
| Period | Medieval Age | 0.6875 | 0 | 0 | |
| | Modern Age | 0.8125 | 0.60 | 0.4875 | |
| | Contemporary | 0.25 | 0.30 | 0.075 | |
| | Age | | | | |
| Art forms | Minor Arts | 0.6875 | 0.10 | 0.0688 | 0.1656 |
| | Pictorial | 0.6250 | 0.15 | 0.0938 | |
| | works | | | | |
| | Sculptures | 0.6250 | 0.35 | 0.2188 | |
| | monuments | | | | |
| | Architecture | 0.5625 | 0.50 | 0.2813 | |

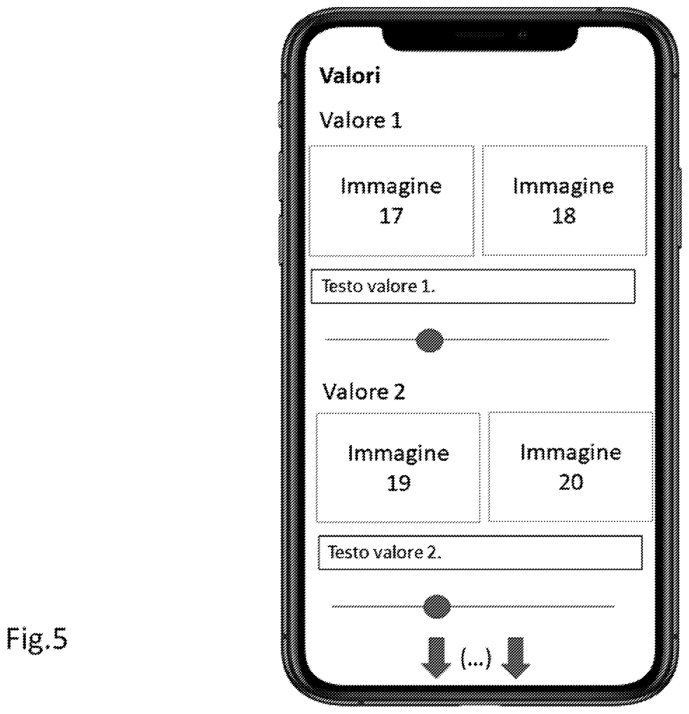

In the next step, illustrated in FIG. 5, the user will indicate their interests regarding the meaning of the work, the reasons for its creation and the interpretation of the subjects represented.

The user views three photos for each value with an example text box for each and a scroll bar for entering the score.

In this phase, the user is asked to assign scores from 0 to 1 to 6 categories of “values”. These values are the same as those entered in the database 3, with the exception of the “functional” value which will not be taken into consideration in this procedure.

The scores entered by the user will be proportioned with the corresponding “value” (percentage, from database 3). An overall score will be assigned for the “values” macro-category resulting from the average of the weights of each value (similar procedure for calculating the score of the “art form” and the “historical period”).

In Table 5 an example:

TABLE 5

| Question- | Database | Values of |
|---|---|---|
| naire | 3 | interest |

Place 1

| | | | | | |
|---|---|---|---|---|---|
| Values | Celebratory | 0.50 | 0.50 | 0.25 | 0.1000 |
| | Personal | 0.65 | 0 | 0 | |
| | Sacred | 0.80 | 0 | 0 | |
| | Social | 0.55 | 0 | 0 | |
| | Symbolic | 0.70 | 0.50 | 0.35 | |
| | Political | 0.25 | 0 | 0 | |

Place 2

| | | | | | |
|---|---|---|---|---|---|
| Values | Celebratory | 0.50 | 0 | 0 | 0.1046 |
| | Personal | 0.65 | 0 | 0 | |
| | Sacred | 0.80 | 0 | 0 | |
| | Social | 0.55 | 0.25 | 0.14 | |
| | Symbolic | 0.70 | 0.70 | 0.49 | |
| | Political | 0.25 | 0 | 0 | |

At the end of the process, the machine collects and analyzes all the inputs entered by the user (Database 5) and assigns a value to each place on the map.

This value is the sum of the values obtained at each step of the questionnaire.

For the answers to the questionnaire on the historical period and on the form of art, those of the example in Table 2 are used.

For the answers to the questionnaire on values, those of the example in Table 3 are used.

The weighted values between the answers to the questionnaire and the percentage values of the database 3 for 4 real places were calculated below:

TABLE 2

| | | | | | | Value |
|---|---|---|---|---|---|---|
| | | Panoramic view - | 2.1 Historical | 2.2 Art | 3. | Of |
| | 1. Type | YES/NO | period | Form | Values | Interest |
| Palazzo 1 | 0.28 | 0.00 | 0.2031 | 0.1469 | 0.0867 | 0.717 |
| Chiesa 2 | 0.28 | 0.00 | 0.161 | 0.1484 | 0.0946 | 0.684 |
| Piazza 3 | 0.3175 | 0.00 | 0.1703 | 0.1453 | 0.0767 | 0.710 |
| Giardino 4 | 0.34375 | 0.15 | 0.0625 | 0.1437 | 0.085 | 0.785 |

For “1. Type” the result is obtained from the type:
Palace 1 and Church 2=Architecture=0.28;
Square 3=Urban planning=0.3175;
Garden 4=Park=0.34375.

The panoramic view is “YES” so a value will be assigned to those places with a view (Garden 4).

TABLE 3

| | | | | | Value |
|---|---|---|---|---|---|
| | Ancient | Medieval | Modern | Contemporary | Of |
| | Age | Age | Age | Age | Interest |
| Palace 1 | 0 | 0 | 1 | 0 | 0.2031 |
| Church 2 | 0 | 0 | 0.70 | 0.30 | 0.161 |
| Square 3 | 0.10 | 0.10 | 0.80 | 0.20 | 0.1703 |
| Garden 4 | 0 | 0 | 0 | 1 | 0.0625 |

Palace 1=(1*0.8125)/4; Church 2=(0.7*0.8125+0.3*0.25)/4; Square 3=(0.1*0.75+0.1*0.6875+0.6*0.8125+0.2*0.25)/4; Garden 4=(1*0.25)/4.

TABLE 4

| | Minor | Pictural | Sculptures/ | | Value of |
|---|---|---|---|---|---|
| | Arts | Works | Monuments | Architecture | Interest |
| Palazzo 1 | 0 | 0.30 | 0.10 | 0.60 | 0.1469 |
| Chiesa 2 | 0.10 | 0.15 | 0.15 | 0.60 | 0.1484 |
| Piazza 3 | 0 | 0 | 0.30 | 0.70 | 0.1453 |
| Giardino 4 | 0 | 0 | 0.20 | 0.80 | 0.1437 |

Palace 1=(0.3*0.6250+0.1*0.6250+0.6*0.5625)/4; Church 2=(0.1*0.6875+0.15*0.625+0.15*0.625+0.6*0.5625)/4; Square 3=(0.3*0.625+0.7*0.5625)/4; Garden 4=(0.2*0.625+0.8*0.5625)/4.

For the “values” the computation is very similar to that for the “historical period” and the “form of art”.

Herein below an example with the same places and hypothetical replies to the al questionnaire:

TABLE 5

| | | | | | | | Value of |
|---|---|---|---|---|---|---|---|
| | Celebratory | Personal | Sacred | Social | Symbolic | Political | interest |
| Questionnaire | 0.50 | 0.65 | 0.80 | 0.55 | 0.70 | 0.25 | |
| Palazzo 1 | 0 | 0.20 | 0 | 0.30 | 0.25 | 0.20 | 0.0867 |
| Chiesa 2 | 0 | 0 | 0.30 | 0.25 | 0.20 | 0.20 | 0.0946 |
| Piazza 3 | 0.20 | 0 | 0 | 0.35 | 0.15 | 0.25 | 0.0767 |
| Giardino 4 | 0.15 | 0.10 | 0 | 0.65 | 0 | 0.05 | 0.085 |

Palace 1=(0.2*0.65+0.3*0.55+0.25*0.7+0.2*0.25)/6; Church 2=(0.3*0.8+0.25*0.55+0.2*0.7+0.2*0.25)/6; Square 3=(0.2*0.5+0.35*0.55+0.15*0.7+0.25*0.25)/6; Garden 4=(0.15*0.5+0.1*0.65+0.65*0.55+0.05*0.25)/6.

The score of interest attributed to each place is the sum of the weighted values of the macro-categories.

Taking up the results of Table 6, they are listed in descending order:
1. Garden 4=0.785
2. Palace 1=0.717
3. Square 3=0.710
4. Church 2=0.684

This will give priority to places with a higher level of interest.

The calculation of the route will also take into consideration the travel time and an estimated time of visit for each place, while the places that do not fall within the specified budget will be filtered.

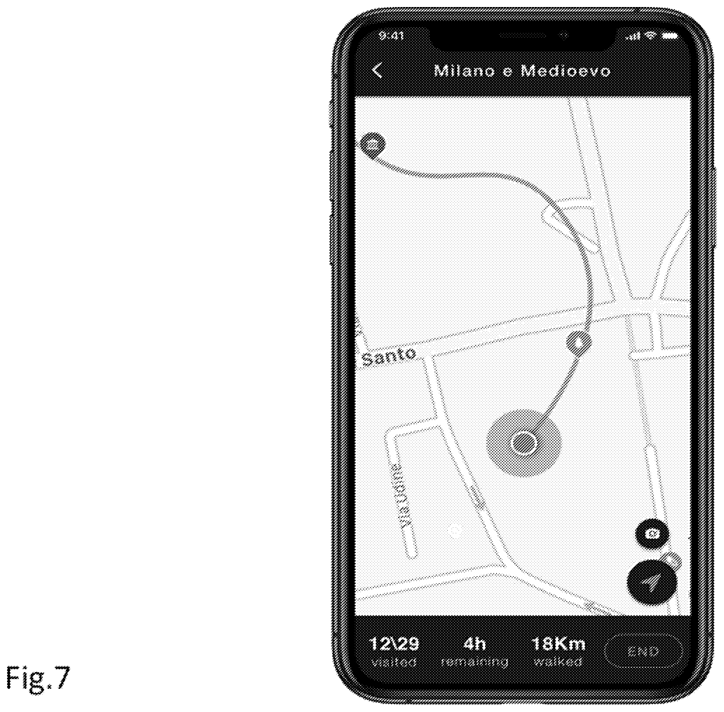

In the last screen, FIG. 7, the map will be shown with the places identified and those selected by the user, the route that the user will follow, and other information such as the real duration of the tour and the portion of the budget that can be spent.

The user can choose between two or more tours with the ability to change the itinerary before approval.

At the end of the route, the tour will be saved with the itinerary followed, the places visited and the contents associated with them.

An apparatus 1 is also provided for organizing flexible and customized tourist itineraries: this apparatus 1 comprises computer-readable instructions which, when executed, carry out the procedure as described above.

For this purpose, this apparatus 1 is equipped at least with display means (not illustrated) to present the above-mentioned screens to the user, with processing means (not illustrated) for processing the algorithms described above, with storage means (not illustrated) to memorize the application programs described above, and of power supply means for powering all the components of the apparatus 1 itself.

Some preferred embodiments of the present invention have been illustrated and described above: obviously, numerous variants and modifications, functionally equivalent to the previous ones, which fall within the scope of the invention as highlighted in the attached claims, will be immediately apparent to those skilled in the art.

1. Process for organizing flexible and customized tourist itineraries, including the steps of:
providing an apparatus for processing and management;
providing a first database containing geographic and tourist data of places of interest, operationally connected to said apparatus;
providing a second database containing user data, operationally connected to said apparatus (1);
registering a user by entering related personal data in said second database;
entering location data and duration of the tourist itinerary, said insertion phase being designed to filter the places to visit within a certain radius of the user and prepare the calculation on the travel time and the visit time, taking into account the maximum duration of the itinerary;
entering data relating to stimuli and type of itinerary, said data being related to nature and relaxation; cultural visit; outdoor visit; visit indoors; and/or panoramic visit, said data being weighted with a value from 0 to 1 with respect to the qualifications of the itinerary in the form of architecture; urban planning and pictorial and sculptural work; museum; park and garden; and/or archaeological site, said stimuli and type data and said qualification data being linked together by a Table of rules, each data entered by the user being multiplied by the constant value of every category, indicated in the Table of rules, a matrix being created with partial values for every category;
displaying to the user a plurality of sections, preferably at least 4 sections, with a plurality, preferably at least 4, of images each, each section+image representing the following two themes: the first is one of the 4 historical periods, ancient age, medieval, modern and contemporary, the second expresses the form of art among the 4 most representative categories and grouped according to similarities, minor arts, painting, sculpture and architecture, each image for each of the 4 sections representing a historical period and a form of art, in pairs without the same pair being repeated, the user indicating his preferences by ranking from 1 (the best) to 4 (the worst) on each image for each section, a score being attributed for each image in this way:
1=1; 2=0.75; 3=0.50; 4=0.25;
displaying to the user at least one photo for each value and a text box, where some questions will be inserted to help the user understand what the values represented refer to and give an idea of what the topics covered in the contents will be, the user by entering a score expressed in numerical value from 0 to 1 for each of the categories, Celebratory, Personal, Sacred, Social, Symbolic, Political, a seventh category being represented as a drop-down menu with artists to be selected;
processing the preferences entered by the user, resulting in a value of interest on each mapped place; and
computing the reported preferences resulting in a “value of interest” on each mapped place and present an itinerary with the number of places to visit, visit time and distance to be traveled.

2. Process according to claim 1, wherein said Table of rules is as follows:

| | Architec- | Urban | Muse- | Garden/ | Archaeological |
|---|---|---|---|---|---|
| | ture | planning | um | park | Site |
| Cultural visit | 0.2 | 0.15 | 0.25 | 0.05 | 0.2 |
| Nature and | 0.1 | 0.15 | 0.05 | 0.225 | 0.15 |
| relaxation | | | | | |
| Outdoor visit | 0.1 | 0.2 | 0.05 | 0.225 | 0.15 |
| Indoor visit | 0.15 | 0.05 | 0.2 | 0.05 | 0.05 |

3. Process according to claim 1, wherein the “value of interest” is calculated as follows:
1.1 Info-stimuli→sum by type of the 4 categories−Architecture=cultural+nature+open/closed+panoramic; Archaeological site=cultural+nature+open/closed+panoramic; the value thus obtained being attributed to all the places identified with that typology;
2. View-characterization→proportion between average user values and attributes of the place; Historical period=average (ancient of the place*average ancient user+medieval of the place*average medieval user); Form of art=same formula of the historical period, both being calculated on each place and as a result being attributed two “values of interest” for each place;
3. Values-questions→given that the detection scale is the same as the attributes of the places, the correspondence between the user's values and the values of the place is detected by attributing a proportional weight with the same formula used in section “2. View-characterization” for “historical period” and “art form”, the “value of interest” for each place being the sum of each result.

4. Process according to claim 1, further comprising the step of entering budget data relating to places with paid entry, said step being designed to include or exclude from the itinerary the places, which respectively fall within or outside the budget estimated by the user.

5. (canceled)

6. A process for creating a customized itinerary for a user for a selected geographical location, the process comprising the steps of:
(a) providing a processor;
(b) providing a first database operationally connected to the processor and configured to include tourist data relating to the selected geographical area;
(c) providing a second database operationally connected to the processor and configured to include user data;
(d) registering the user by entering identifying user data in the second database;
(e) entering visit user data provided by the user for the selected location into the second database, including visit time and input relating to type of visit;
(f) displaying to the user at least 16 images;
(g) collecting ratings of the images from the user;
(h) computing user preferences based on the image ratings;
(i) mapping potential places to visit within the geographical area based on the visit user data and the tourist data;
(j) computing a value of interest for the potential places to visit based on the computed user preferences, the visit time, and the type of visit;
(k) providing the user with an itinerary comprising a list of places to visit selected from the potential places to visit, based on the value of interest of each place, the distance to each place, and the time required to visit each place.

7. The process of claim 6 wherein the input relating to type of visit is based on categories of cultural visit; nature and relaxation; indoor visit; outdoor visit.

8. The process of claim 6 wherein the step of computing user preferences includes the step of assigning weights to types of places.

9. The process of claim 6 wherein types of places are chosen from of architecture; urban planning; pictorial and sculptural work; museum; park and garden; archaeological site.

11. The process of claim 6 wherein the images and data are chosen based on types of places.

12. The process of claim 6 wherein visit user data further includes budget and tourist data includes fees charged to visit potential places to visit.
